(19) United States
(12) Patent Application Publication
(10) Pub. No.: US 2025/0201907 A1
(43) Pub. Date: Jun. 19, 2025

(54) SOLID LITHIUM BATTERY

(71) Applicant: Chung Yuan Christian University, Taoyuan City (TW)

(72) Inventors: Wei-Jen Liu, Taoyuan City (TW); Yu Lo, Taoyuan City (TW); Shih Ping Cho, Taoyuan City (TW); Chung Ping Chou, New Taipei City (TW); Chin Wang Lee, Tainan City (TW)

(73) Assignee: Chung Yuan Christian University, Taoyuan City (TW)

(21) Appl. No.: 18/590,961

(22) Filed: Feb. 29, 2024

(30) Foreign Application Priority Data
Dec. 13, 2023 (TW) 112148451

(51) Int. Cl. H01M 10/0562; H01M 4/133; H01M 4/136; H01M 10/0525

(52) U.S. Cl. CPC H01M 10/0562; H01M 4/133; H01M 4/136; H01M 10/0525; H01M 2300/0068

(57) ABSTRACT

A solid lithium battery includes a negative electrode layer, a solid electrolyte layer, and a positive electrode layer. The solid electrolyte layer includes a first solid electrolyte. The positive electrode layer includes an active material, a second solid electrolyte, a conductive additive, and an adhesive. A material of the second solid electrolyte includes oxygen-doped sulfide or lithium indium chloride and/or a material of the conductive additive includes graphene.

### CROSS-REFERENCE TO RELATED APPLICATION

This application claims the priority benefit of Taiwan application serial no. 112148451, filed on Dec. 13, 2023. The entirety of the above-mentioned patent application is hereby incorporated by reference herein and made a part of this specification.

### BACKGROUND

### Technical Field

This disclosure is related to a solid lithium battery.

### Description of Related Art

Lithium batteries are currently widely used in energy storage devices, such as laptops, mobile phones, electric vehicle industries, etc. However, due to many problems with liquid lithium batteries, therefore, in recent years, the research on solid lithium batteries has received increasing attention since solid lithium batteries have no dangers of leakage, volatilization, combustion and explosion, while during the charging and discharging process, they can reduce the probability of lithium dendrites penetrating the electrolyte and bringing the positive and negative electrodes into contact, and they have high ion conductivity and high electrochemical window.

Furthermore, in solid lithium batteries, the solid-solid interface between the electrode and the solid electrolyte has the large interface contact resistance, and when the electrode and the solid electrolyte are in contact, side reactions may occur, which will affect its electrochemical stability and electrical performance.

### SUMMARY

The disclosure provides a solid lithium battery which has better electrochemical stability while maintaining electrical performance.

A solid lithium battery of the disclosure includes a negative electrode layer, a solid electrolyte layer, and a positive electrode layer. The solid electrolyte layer includes a first solid electrolyte. The positive electrode layer includes an active material, a second solid electrolyte, a conductive additive, and an adhesive. A material of the second solid electrolyte includes oxygen-doped sulfide or lithium indium chloride (Li₃InCl₆) and/or a material of the conductive additive includes graphene.

In an embodiment of the disclosure, the oxygen-doped sulfide includes Li₆PS₅₋ₓClOₓ, Li₆PS₅₋ₓBrOₓ, Li₆PS₅₋ₓIOₓ or a combination thereof, x=0˜1.

In an embodiment of the disclosure, a weight ratio of the second solid electrolyte to a total weight of the positive electrode layer is greater than 20 wt %.

In an embodiment of the disclosure, a weight ratio of the conductive additive to the total weight of the positive electrode layer is less than 20 wt %.

In an embodiment of the disclosure, a weight ratio of the active material to the total weight of the positive electrode layer ranges from 60 wt % to 80 wt %.

In an embodiment of the disclosure, a weight ratio of the adhesive to the total weight of the positive electrode layer ranges from 1 wt % to 5 wt %.

In an embodiment of the disclosure, a number of layers of the graphene ranges from 3 layers to 20 layers.

In an embodiment of the disclosure, a material of the first solid electrolyte is same as a material of the second solid electrolyte.

In an embodiment of the disclosure, the material of the conductive additive further includes carbon black, gas phase carbon fiber, or carbon nanotube.

In an embodiment of the disclosure, a material of the negative electrode layer includes lithium, indium or a combination thereof.

Based on the above, the solid lithium battery of the disclosure at least adopts the design of the positive electrode layer which introduces the second solid electrolyte and/or conductive additive with lower reactivity therein, such that the solid lithium battery has better electrochemical stability while maintaining electrical performance.

In order to make the above-mentioned features and advantages of the present disclosure comprehensible, embodiments accompanied with drawings are described in detail below.

### BRIEF DESCRIPTION OF THE DRAWINGS

FIG. 1 is a schematic exploded view of the solid lithium battery of the disclosure.

FIG. 2, FIG. 3, FIG. 4, FIG. 5, FIG. 6, FIG. 7, FIG. 8, and FIG. 9 are charge and discharge curves of some examples.

FIG. 10 is an initial charge and discharge curve of some examples.

FIG. 11 is a discharge capacitance curve of some examples.

FIG. 12, FIG. 13, FIG. 14, and FIG. 15 are the discharge capacity and coulombic efficiency curves of some examples.

FIG. 16 is an AC impedance diagram of some examples.

### DESCRIPTION OF THE EMBODIMENTS

In the following detailed description, for purposes of explanation and not limitation, exemplary embodiments disclosing specific details are set forth to provide a thorough understanding of various principles of the disclosure. However, it should be apparent to people with ordinary skills in the art that the disclosure may be practiced in other embodiments that depart from the specific details disclosed herein. Furthermore, descriptions of well-known devices, methods, and materials may be omitted so as not to obscure the description of various principles of the disclosure.

Unless otherwise stated, the term “range from” used in the specification to define a value range is intended to cover a range equal to and between the stated endpoint values. For example, a size range ranges from a first value to a second value means that the size range may cover the first value, the second value, and any value between the first value and the second value.

A solid lithium battery in the disclosure includes a negative electrode layer, a solid electrolyte layer and a positive electrode layer, wherein the solid electrolyte layer includes a first solid electrolyte, and the positive electrode layer includes an active material, a second solid electrolyte, a conductive additive, and an adhesive. In addition, a material of the second solid electrolyte includes oxygen-doped sulfide or lithium indium chloride and/or a material of the conductive additive includes graphene, in other words, the disclosure can improve the material of the second solid electrolyte of the positive electrode layer to include oxygen-doped sulfide or lithium indium chloride, or, the disclosure can improve the material of the conductive additive of the positive electrode layer to include graphene, or the disclosure can simultaneously improve the material of the second solid electrolyte of the positive electrode layer and the material of the conductive additive of the positive electrode layer through the aforementioned manners.

Accordingly, the solid lithium battery of the disclosure at least adopts the design of the positive electrode layer (such as the aforementioned improvement manners) which introduces the second solid electrolyte and/or the conductive additive with lower reactivity therein, such that the solid lithium battery has better electrochemical stability while maintaining electrical performance.

Furthermore, oxygen doping can make sulfide less likely to react with other components in the solid lithium battery, and lithium indium chloride can be used as a buffer layer, and the graphene with fewer surface functional groups is less likely to react with other components in the solid lithium battery, therefore, the selection of these materials can make the solid lithium battery have high energy density and high cycle stability, which will be stated in detail below with examples.

In some embodiments, oxygen-doped sulfide includes Li₆PS₅₋ₓClOₓ, Li₆PS₅₋ₓBrOₓ, Li₆PS₅₋ₓIOₓ or a combination thereof. 1>x>0, and a material of the first solid electrolyte is same as a material of the second solid electrolyte to further enhance the stabilization effect, but the disclosure is not limited thereto. The first solid electrolyte may also use or further include indium trichloride (InCl₃).

In some embodiments, the material of the conductive additive further includes carbon black, gas phase carbon fiber or carbon nanotube, that is to say, the conductive additive may have a combination of graphene and any of the above materials at the same time, for example, the conductive additive may include graphene and carbon black, or, the conductive additive may include graphene and gas phase carbon fiber, or, the conductive additive may include graphene and carbon nanotube. The materials such as carbon black have excellent electrical properties, however, they easily adsorb water molecules, therefore, when it is used alone, the electrochemical stability is not high. When it is used in conjunction with the graphene, characteristic of the graphene not easily adsorbing water molecules can achieve a great balance between the electrochemical stability and electrical performance of the overall solid lithium battery, but the disclosure is not limited thereto.

In some embodiments, a number of layers of the graphene ranges from 3 layers to 20 layers, but the disclosure is not limited thereto.

In some embodiments, the graphene can be prepared using chemical oxidation delamination method, liquid phase exfoliation method, ultrasonic method, chemical vapor deposition method, etc., but the disclosure is not limited thereto, and the graphene can also be prepared using other suitable preparation methods.

In some embodiments, a material of the negative electrode layer includes lithium, indium or a combination thereof. For example, when the material of the negative electrode layer is a lithium-indium alloy, the electrochemical stability of the solid lithium battery can be further improved due to the lithium-indium alloy with lower reactivity and passivation effect, but the disclosure is not limited thereto.

In some embodiments, the active material includes LiNi_{0.8}Co_{0.1}Mn_{0.1}O₂ with polycrystalline, LiNi_{0.6}Co_{0.2}Mn_{0.2}O₂ with polycrystalline, LiNi_{0.5}Co_{0.2}Mn_{0.3}O₂ with polycrystalline, LiNi_{0.8}Co_{0.1}Mn_{0.102} with single crystal, LiNi_{0.6}Co_{0.2}Mn_{0.2}O₂ with single crystal. LiNi_{0.5}Co_{0.2}Mn_{0.3}O₂ with single crystal, LiNi_{0.6}Co_{0.1}Mn_{0.3}O₂, LiFePO₄ or a combination thereof, but the disclosure is not limited thereto.

In some embodiments, a material of the adhesive includes polytetrafluoroethylene (PTFE), rubber, or a combination thereof, but the disclosure is not limited thereto.

In some embodiments, a weight ratio of the second solid electrolyte to a total weight of the positive electrode layer is greater than 20 wt %, a weight ratio of the conductive additive to the total weight of the positive electrode layer is less than 20 wt %, a weight ratio of the active material to the total weight of the positive electrode layer ranges from 60 wt % to 80 wt %, and a weight ratio of the adhesive to the total weight of the positive electrode layer ranges from 1 wt % to 5 wt %, but the disclosure is not limited thereto. In here, the positive electrode layer may be composed of the active material, the second solid electrolyte, the conductive additive and the adhesive, that is, the total weight of the active material, the second solid electrolyte, the conductive additive and the adhesive is equal to the total weight of the positive electrode layer.

In some embodiments, the solid electrolyte layer is composed of a single material or at least two materials, and the negative electrode layer is composed of a single metal material or an alloy material, but the disclosure is not limited thereto.

The solid lithium battery of the disclosure has tighter structure, greater design flexibility . . . longer service life, and is easier to miniaturize through the above design. In addition, it will not cause corrosion of electrodes or accumulation of solid interfaces, resulting in shortened battery life. Some applicable fields of the solid lithium battery in the disclosure are listed below.

In some embodiments, the solid lithium battery of the disclosure has high energy density and fast charge and discharge capabilities when applied to electric vehicles, which can provide longer cruising range and shorter charging time for electric vehicles, and also has higher safety and can reduce the risk like fire or explosion of battery, but the disclosure is not limited thereto.

In some embodiments, the solid lithium battery of the disclosure has high energy density when applied to mobile electronic devices such as smartphones, tablets, and notebook computers, it can be an ideal battery technology, and can also achieve a thinner and lighter design, providing longer battery life and faster charging speed, but the disclosure is not limited thereto.

In some embodiments, when the solid lithium battery of the disclosure is used in wearable devices (such as smart watches, health monitors, and smart glasses), it is lightweight, long battery life, safe and reliable to be a power source, therefore, it can meet the requirements of these devices, but the disclosure is not limited thereto.

In some embodiments, when the solid lithium battery of the disclosure is applied to energy storage systems (such as home energy storage systems, renewable energy storage systems such as solar and wind energy, energy storage of power grids, and peak reduction systems), due to its advantages of efficient energy storage and long cycle life, it promotes to improve energy utilization and the integration of renewable energy, but the disclosure is not limited thereto.

The efficacy of the disclosure will be described in more details below with reference to the solid lithium battery of the disclosure. In addition, although examples below are described, the details of the materials used, the procedures, and the like may be appropriately changed without departing from the scope of the disclosure, wherein the specific material weight ratios are shown in Table 1, and example 1 may be regarded as a comparative example, example 2 to example 11 may be regarded as examples of the disclosure.

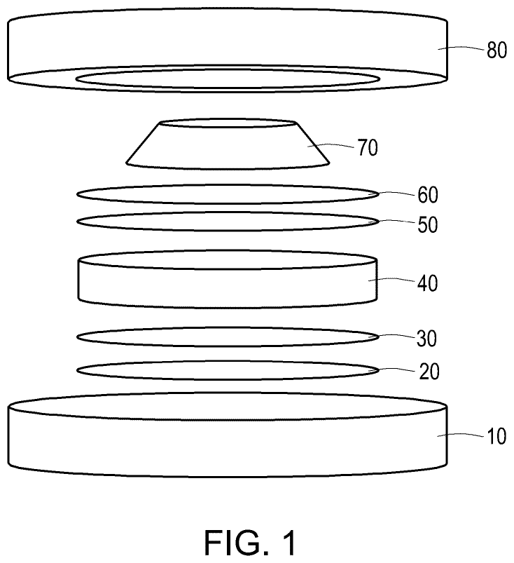

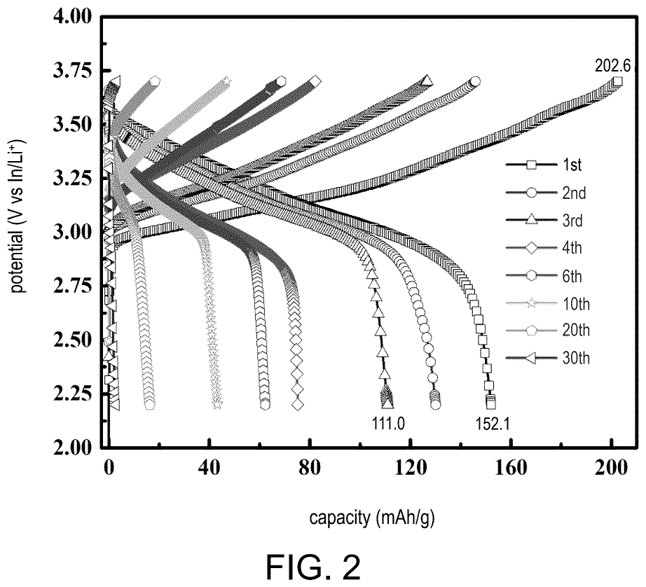

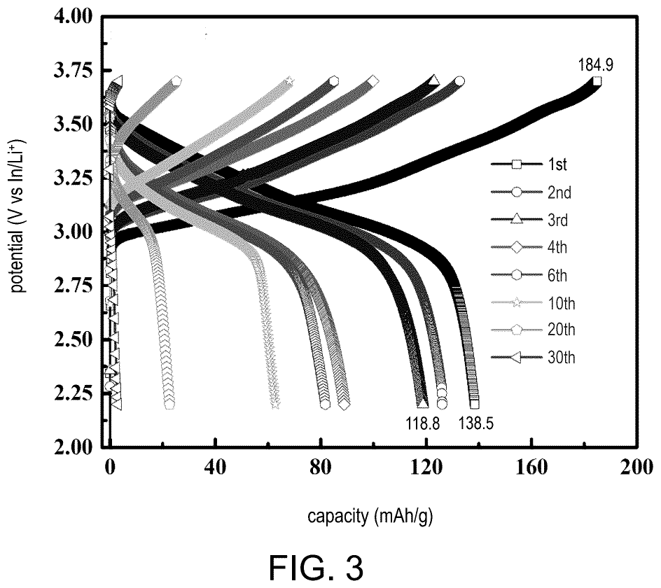

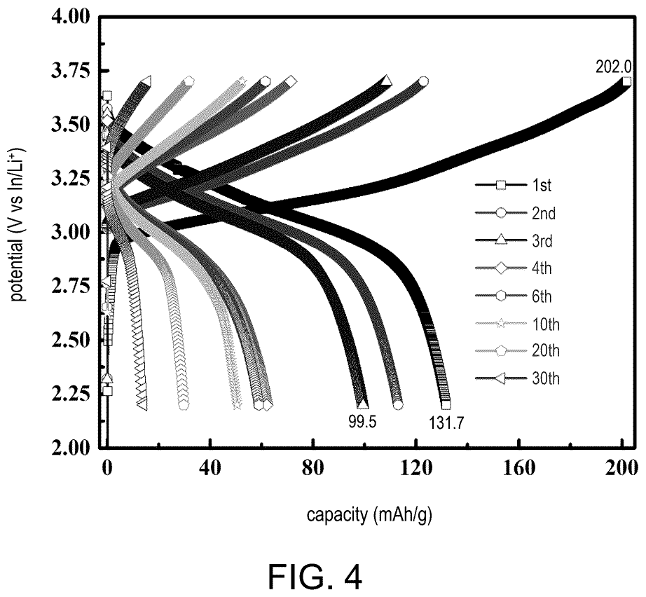

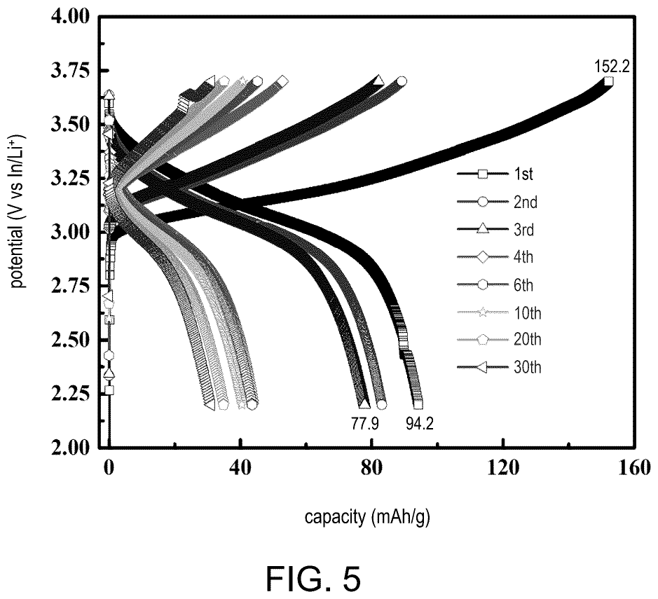

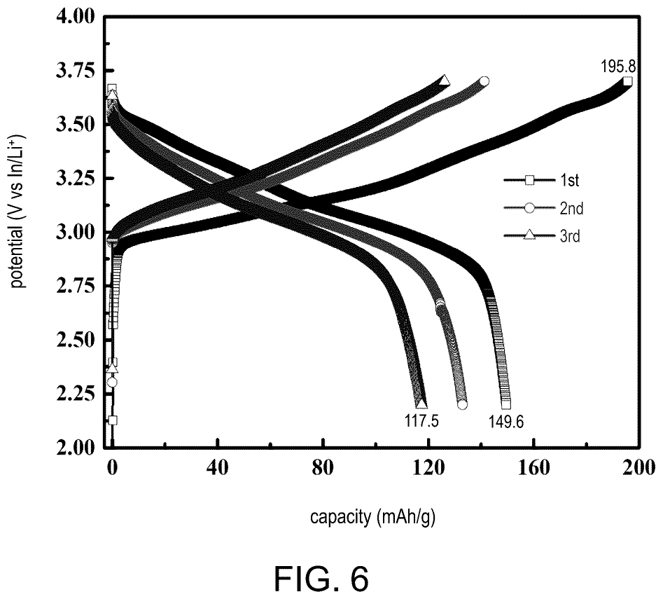

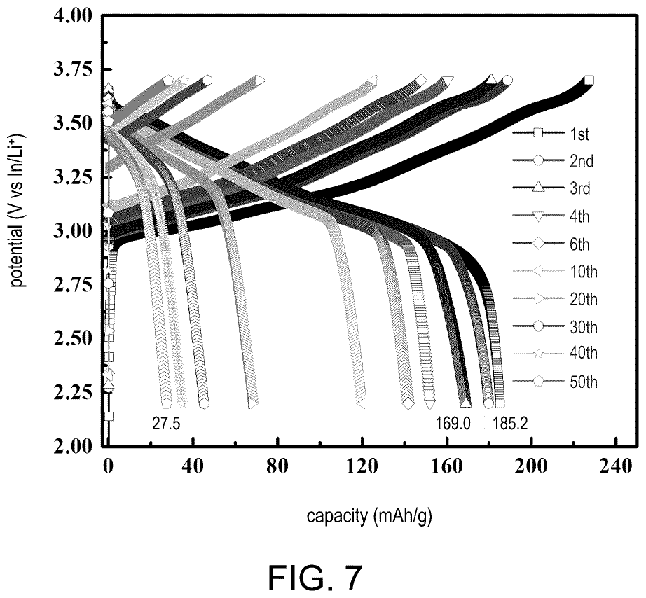

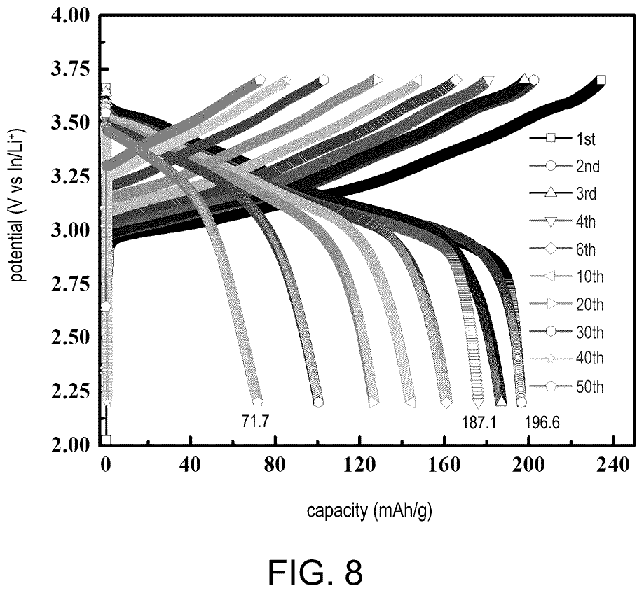

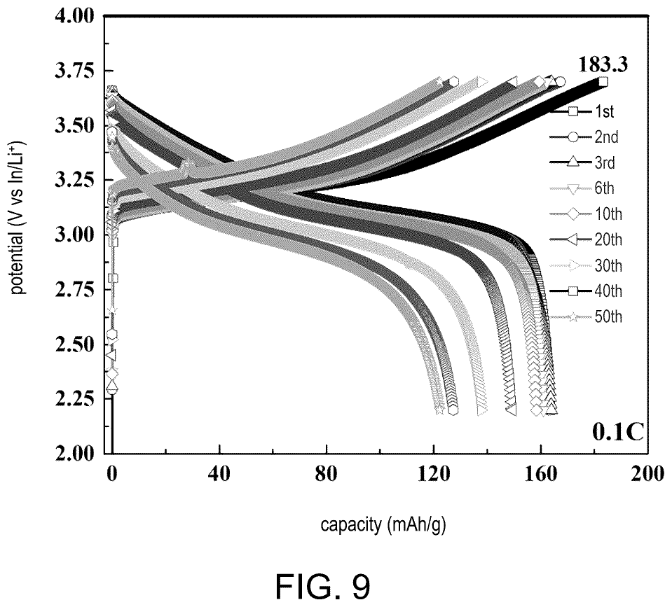

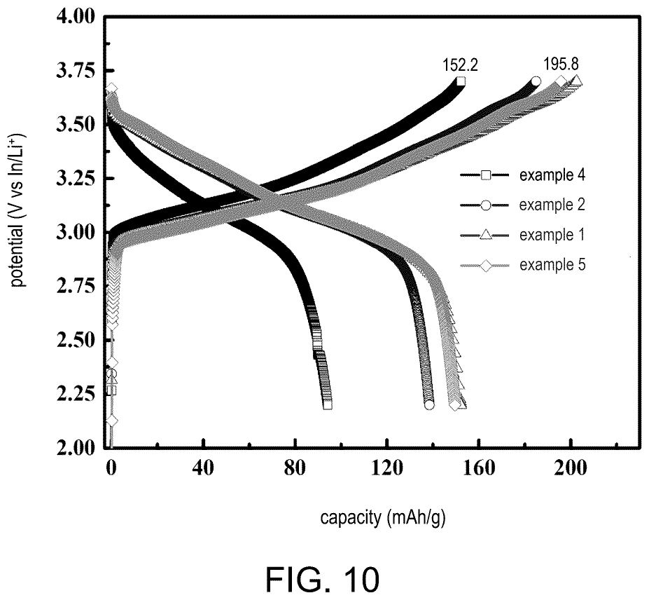

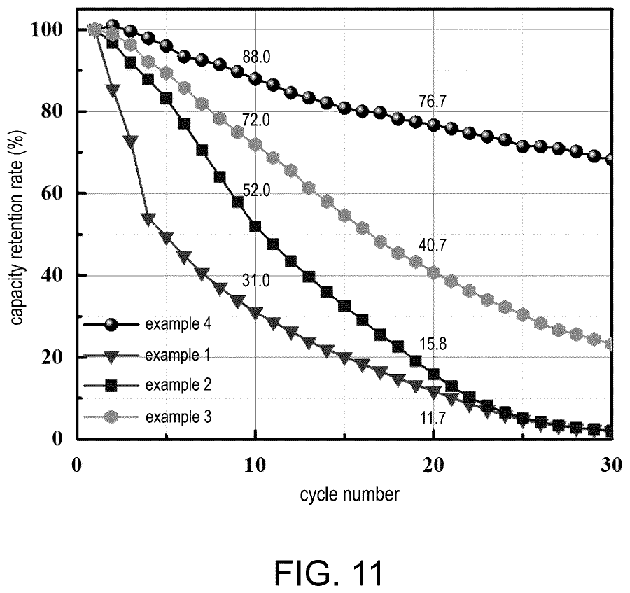

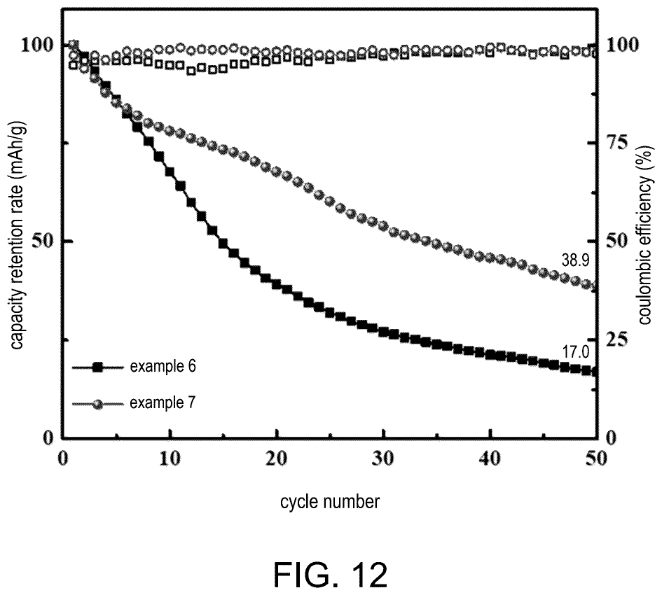

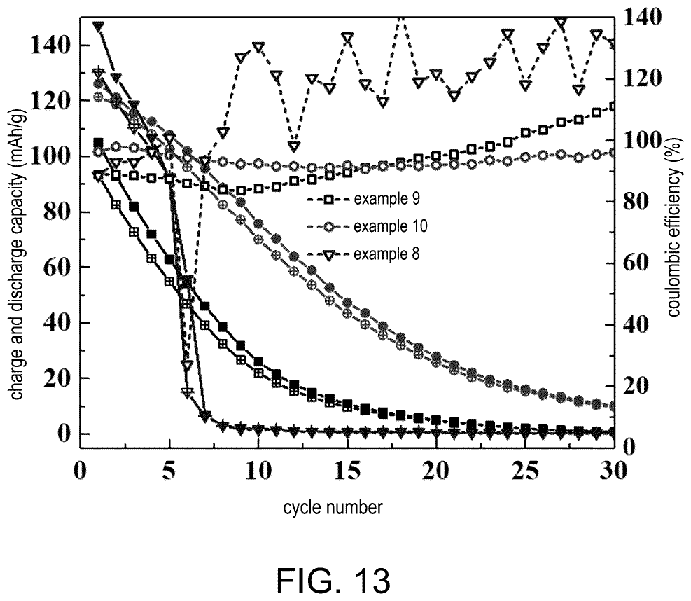

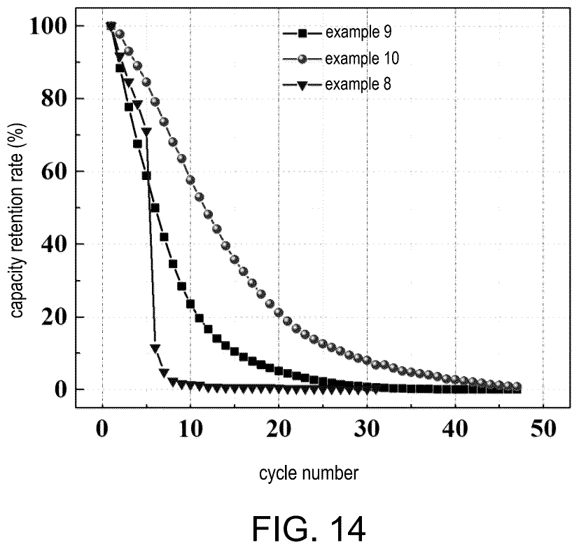

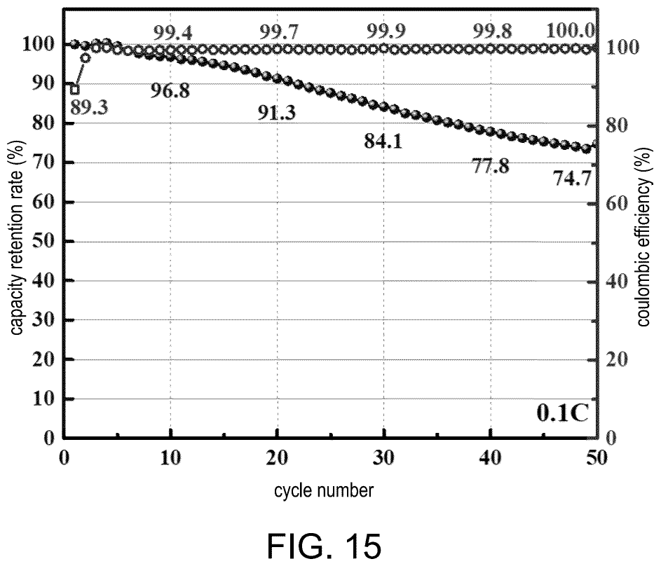

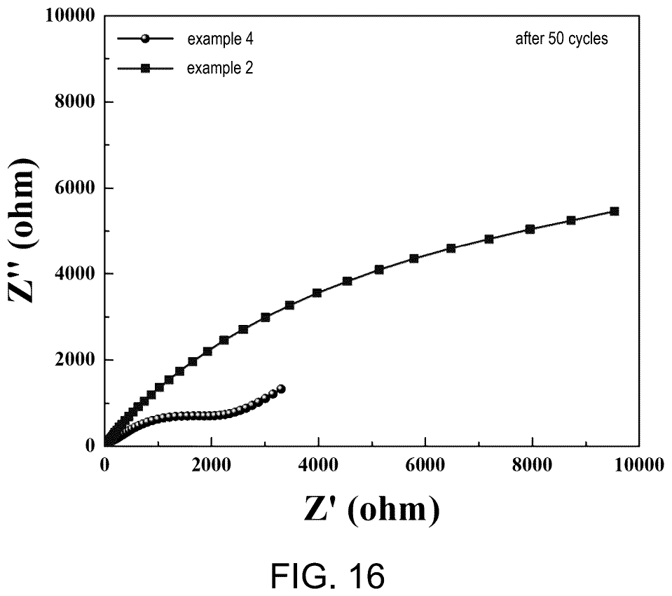

FIG. 1 is a schematic exploded view of the solid lithium battery of the disclosure. FIG. 2, FIG. 3. FIG. 4, FIG. 5, FIG. 6, FIG. 7, FIG. 8, and FIG. 9 are charge and discharge curves of some examples. FIG. 10 is an initial charge and discharge curve of some examples. FIG. 11 is a discharge capacitance curve of some examples. FIG. 12, FIG. 13, FIG. 14, and FIG. 15 are the discharge capacity and coulombic efficiency curves of some examples. FIG. 16 is an AC impedance diagram of some examples. In here, the capacitance in the figures may be a specific capacity.

### Example 1

An active material (LiNi_{0.8}Co_{0.1}Mn_{0.1}O₂ with polycrystalline, PC-NCM811), a solid electrolyte (lithium phosphorus sulfur chloride, LPSCl, Li₆PS₅Cl), and a conductive additive (carbon black. SP) are mixed evenly in a weight ratio of 70 grams:25 grams:5 grams into the mortar, then 3 grams of the adhesive (polytetrafluoroethylene, PTFE) are added to make it be a composite positive electrode film. Next, the aforementioned composite positive electrode film is rolled to a thickness of 50 micrometers (μm) and cut into a circle with a diameter of 10 millimeters (mm) to serve as the positive electrode layer. Then, 0.7 grams of another solid electrolyte (lithium phosphorus sulfur chloride, LPSCl, Li₆PS₅Cl) powder are put into the mold, and cold press it at 360Mpa to make it into an ingot to serve as the solid electrolyte layer which thickness is 450 μm and diameter is 10 millimeters (mm). Finally, the indium metal is cut into a diameter of 10 millimeters (mm) and a thickness of 500 μm using a puncher to serve as the negative electrode layer. As shown in FIG. 1, put a bottom cover 10, an aluminum foil 20, the positive electrode layer 30, the solid electrolyte layer 40, the negative electrode layer 50, a stainless-steel gasket 60, a reed 70, and a top cover 80 in sequence into the CR-2032 button battery. A hydraulic press is used to press the battery at a pressure of 200Mpa, wherein the above processes are all carried out in a glove box filled with argon gas to reduce the probability of the sample being affected by water and oxygen.

### Example 2

The preparation method of the solid lithium battery is similar to that of example 1. The difference is that the conductive additive is replaced by the graphene (FLG) which are 7 layers to 10 layers.

### Example 3

The preparation method of the solid lithium battery is similar to that of example 1. The difference is that the ratio of the active material, the solid electrolyte, the conductive additive (carbon black), and the conductive additive (graphene) in the composite positive electrode film is 70 grams: 25 grams: 2.5 grams: 2.5 grams.

### Example 4

The preparation method of the solid lithium battery is similar to that of example 1. The difference is that the conductive additive in the composite positive electrode film is replaced by the graphene, and the ratio of the active material, the solid electrolyte, and the conductive additive is 70 grams: 20 grams: 10 grams.

### Example 5

The preparation method of the solid lithium battery is similar to that of example 1. The difference is that the conductive additive in the composite positive electrode film is replaced by the graphene, and the ratio of the active material, the solid electrolyte, and the conductive additive is 65 grams: 25 grams: 10 grams.

### Example 6

A solid electrolyte (LPSCl-1) is first synthesized in the following manner for later use. First, the precursors like Li₂S, P₂S₅, and LiCl were put into a mortar in a molar ratio of 2.5:0.5:1 and mixed evenly. The above process was performed in a glove box filled with argon. Next, the hand-ground powder is put into a carbon-coated quartz tube, and sealing the tube after the pressure inside the quartz tube is pumped to about 2×10⁻² Torr using a maintainer and vacuum system. Then, the quartz tube containing the powder was sintered at a high temperature of 550° C. for 5 hours, with a heating rate of 5° C. per minute, and then naturally cooled to room temperature, and then ground into powder with a mortar.

The active material (LiNi_{0.8}Co_{0.1}Mn_{0.1}O₂ with polycrystalline, PC-NCM811), the solid electrolyte (LPSCl-1), the conductive additive (carbon black), and the conductive additive (gas phase carbon fiber, VGCF) are put into a mortar and mixed evenly in a weight ratio of 70 grams:30 grams:1.5 grams: 1.5 grams, then 3 grams of the adhesive (polytetrafluoroethylene, PTFE) is added to make it be a composite positive electrode film. Next, the aforementioned composite positive electrode film is rolled to a thickness of 50 micrometers (μm) and cut into a circle with a diameter of 10 millimeters (mm) to serve as the positive electrode layer. Then, 0.7 grams of another solid electrolyte (LPSCl-1) powder are put into the mold, and cold press it at 360Mpa to make it into an ingot to serve as the solid electrolyte layer which thickness is 450 μm and diameter is 10 millimeters (mm). Finally, the indium metal is cut into a diameter of 10 millimeters (mm) and a thickness of 500 μm using a puncher to serve as the negative electrode layer. As shown in FIG. 1, put the bottom cover 10, the aluminum foil 20, the positive electrode layer 30, the solid electrolyte layer 40, the negative electrode layer 50, the stainless-steel gasket 60, the reed 70, and the top cover 80 in sequence into the CR-2032 button battery. A hydraulic press is used to press the battery at a pressure of 200Mpa, wherein the above processes are all carried out in a glove box filled with argon gas to reduce the probability of the sample being affected by water and oxygen.

### Example 7

A solid electrolyte (LPSClO-0.1) including oxygen doped material is first synthesized in the following manner for later use. First, the precursors like Li₂S, P₂S₅, LiCl, and Li₂O are put into a mortar in a molar ratio of 2.4:0.5:1:0.1 and mixed evenly. The above process is performed in a glove box filled with argon. Next, the hand-ground powder is put into a carbon-coated quartz tube, and sealing the tube after the pressure inside the quartz tube is pumped to about 2×10⁻² Torr using a maintainer and vacuum system. Then, the quartz tube containing the powder was sintered at a high temperature of 550° C. for 5 hours, with a heating rate of 5° C. per minute, and then naturally cooled to room temperature, and then ground into powder with a mortar.

The active material (LiNi_{0.8}Co_{0.1}Mn_{0.1}O₂ with polycrystalline, PC-NCM811), the solid electrolyte (LPSClO-0.1), the conductive additive (carbon black), and the conductive additive (gas phase carbon fiber) are mixed evenly in a weight ratio of 70 grams:30 grams:1.5 grams:1.5 grams into the mortar, then 3 grams of the adhesive (polytetrafluoroethylene, PTFE) is added to make it be a composite positive electrode film. Next, the aforementioned composite positive electrode film is rolled to a thickness of 50 micrometers (μm) and cut into a circle with a diameter of 10 millimeters (mm) to serve as the positive electrode layer. Then, 0.7 grams of another solid electrolyte (LPSClO-0.1) powder are put it into the mold, and cold-press it at 360Mpa to make it into an ingot to serve as the solid electrolyte layer which thickness is 450 μm and its diameter is 10 mm. Finally, the indium metal is cut into a diameter of 10 millimeters (mm) and a thickness of 500 μm using a puncher to serve as the negative electrode layer. As shown in FIG. 1, put the bottom cover 10, the aluminum foil 20, the positive electrode layer 30, the solid electrolyte layer 40, the negative electrode layer 50, the stainless-steel gasket 60, the reed 70, and the top cover 80 in sequence into the CR-2032 button battery. A hydraulic press is used to press the battery at a pressure of 200Mpa, wherein the above processes are all carried out in a glove box filled with argon gas to reduce the probability of the sample being affected by water and oxygen.

### Example 8

The active material (LiNi_{0.8}Co_{0.1}Mn_{0.1}O₂ with polycrystalline, PC-NCM811), the solid electrolyte (lithium indium chloride material, Li₃InCl₆), and the conductive additive (gas phase carbon fiber) are mixed evenly in a weight ratio of 70 grams:30 grams:3 grams into a mortar, then 3 grams of adhesive (polytetrafluoroethylene, PTFE) is added to make it be a composite positive electrode film. Next, the aforementioned composite positive electrode film is rolled to a thickness of 50 μm and cut into a circle with a diameter of 10 mm to serve as the positive electrode layer. Then, 0.5 grams of another solid electrolyte (lithium indium chloride material, Li₃InCl₆) powder are put into the mold, and cold press it at 360Mpa to make it into an ingot, then 0.7 grams of another solid electrolyte (lithium phosphorus sulfur chloride, LPSCl, Li₆PS₅Cl) powder are put into the mold, cold press it at 360Mpa to make it into a double-layer tablet to serve as the solid electrolyte layer which thickness is 450 μm and diameter is 10 mm. Finally, the lithium metal is cut into a diameter of 10 millimeters (mm) and a thickness of 500 μm using a puncher to serve as the negative electrode layer. As shown in FIG. 1, put the bottom cover 10, the aluminum foil 20, the positive electrode layer 30, the solid electrolyte layer 40, the negative electrode layer 50, the stainless-steel gasket 60, the reed 70, and the top cover 80 in sequence into the CR-2032 button battery. A hydraulic press is used to press the battery at a pressure of 200Mpa, wherein the above processes are all carried out in a glove box filled with argon gas to reduce the probability of the sample being affected by water and oxygen.

### Example 9

The preparation method of the solid lithium battery is similar to that of example 8. The difference is that the material of the negative electrode layer is replaced with the indium.

### Example 10

The preparation method of the solid lithium battery is similar to that of example 8. The difference is that the material of the negative electrode layer is replaced by lithium indium alloy, wherein, indium metal is on the top and lithium metal is on the bottom. They are stacked together and cold-pressed at 20Mpa to form the lithium-indium alloy. The weight ratio of lithium metal to indium metal is 2:55.

### Example 11

The active material (LiNi_{0.6}Co_{0.1}Mn_{0.3}O₂ with single crystal, SC-NCM613), the solid electrolyte (lithium indium chloride material, Li₃InCl₆), the conductive additive (carbon black), and the conductive additive (gas phase carbon fiber) are mixed evenly in a weight ratio of 70 grams:1.5 grams:1.5 grams into a mortar, then 3 grams of the adhesive (polytetrafluoroethylene, PTFE) is added to make it be a composite positive electrode film. Next, the aforementioned composite positive electrode film is rolled to a thickness of 50 μm and cut into a circle with a diameter of 10 mm to serve as the positive electrode layer. Then, 0.5 grams of solid electrolyte (lithium indium chloride material, Li₃InCl₆) powder are put into the mold, and cold pressed at 360Mpa to make it into an ingot, and then 0.7 grams of another solid electrolyte (LPSClO-0.1 produced in example 7) powder are put into the mold and cold pressed at 360Mpa to make it into a double-layer tablet to serve as the solid electrolyte layer which thickness is 450 μm and diameter is 10 mm. Finally, the indium metal and lithium metal are cut into diameter of 10 mm and thickness of 550 μm using a puncher. The indium metal is on top and the lithium metal is on the bottom. They are stacked together and cold-pressed at 20Mpa to form a lithium-indium alloy, the weight ratio of lithium metal and indium metal is 2:55. As a negative electrode layer, as shown in FIG. 1, the bottom cover 10, the aluminum foil 20, the positive electrode layer 30, the solid electrolyte layer 40, the negative electrode layer 50, the stainless-steel gasket 60, the reed 70 and the top cover 80 are placed in the CR-2032 button battery in sequence. A hydraulic press is used to press the battery at a pressure of 200Mpa, wherein the above processes are all carried out in a glove box filled with argon gas to reduce the chance of the sample being affected by water and oxygen.

TABLE 1

| | positive electrode layer | | | | | | | negative |
|---|---|---|---|---|---|---|---|---|
| | active | solid | conductive | | | | | electrode |
| | material | electrolyte | additive | | adhesive | solid electrolyte layer | | layer |
| Example | PC-NCM811 | LPSCl | SP | | PTFE | LPSCl | | In |
| 1 | (68 wt %) | (24 wt %) | (5 wt %) | | (3 wt %) | (100 wt %) | | (100 wt %) |
| Example | PC-NCM811 | LPSCl | FLG | | PTFE | LPSCl | | In |
| 2 | (68 wt %) | (24 wt %) | (5 wt %) | | (3 wt %) | (100 wt %) | | (100 wt %) |
| Example | PC-NCM811 | LPSCl | SP | FLG | PTFE | LPSCl | | In |
| 3 | (68 wt %) | (24 wt %) | (2.5 wt %) | (2.5 wt %) | (3 wt %) | (100 wt %) | | (100 wt %) |
| Example | PC-NCM811 | LPSCl | FLG | | PTFE | LPSCl | | In |
| 4 | (68 wt %) | (19 wt %) | (10 wt %) | | (3 wt %) | (100 wt %) | | (100 wt %) |
| Example | PC-NCM811 | LPSCl | FLG | | PTFE | LPSCl | | In |
| 5 | (63 wt %) | (24 wt %) | (10 wt %) | | (3 wt %) | (100 wt %) | | (100 wt %) |
| Example | PC-NCM811 | LPSCl-1 | SP | FLG | PTFE | LPSCl-1 | | In |
| 6 | (66 wt %) | (28 wt %) | (1.5 wt %) | (1.5 wt %) | (3 wt %) | (100 wt %) | | (100 wt %) |
| Example | PC-NCM811 | LPSClO-0.1 | SP | FLG | PTFE | LPSClO-0.1 | | In |
| 7 | (66 wt %) | (28 wt %) | (1.5 wt %) | (1.5 wt %) | (3 wt %) | (100 wt %) | | (100 wt %) |
| Example | PC-NCM811 | Li₃InCl₆ | VGCF | | PTFE | Li₃InCl₆ | LPSCl | Li |
| 8 | (66 wt %) | (28 wt %) | (3 wt %) | | (3 wt %) | (50 wt %) | (50 wt %) | (100 wt %) |
| Example | PC-NCM811 | Li₃InCl₆ | VGCF | | PTFE | Li₃InCl₆ | LPSCl | In |
| 9 | (66 wt %) | (28 wt %) | (3 wt %) | | (3 wt %) | (50 wt %) | (50 wt %) | (100 wt %) |
| Example | PC-NCM811 | Li₃InCl₆ | VGCF | | PTFE | Li₃InCl₆ | LPSCl | LiIn |
| 10 | (66 wt %) | (28 wt %) | (3 wt %) | | (3 wt %) | (50 wt %) | (50 wt %) | (100 wt %) |
| Example | SC-NCM613 | Li₃InCl₆ | SP | VGCF | PTFE | Li₃InCl₆ | LPSClO-0.1 | LiIn |
| 11 | (66 wt %) | (28 wt %) | (1.5 wt %) | (1.5 wt %) | (3 wt %) | (50 wt %) | (50 wt %) | (100 wt %) |

Each example is evaluated according to the method described below.

The charge and discharge curves of FIG. 2, FIG. 3, FIG. 4, FIG. 5, FIG. 6, FIG. 7, FIG. 8, and FIG. 9 correspond to example 1, example 2, example 3, example 4, example 5, example 6, and example 7 and example 11, respectively. The operating conditions are 3 cycles at 0.05 C and 30 or 50 cycles at 0.1 C, the voltage range is 2.2V to 3.7V, and the temperature is 55° C.

The initial charge and discharge curves in FIG. 10 correspond to example 1, example 2, example 4, and example 5, and the operating conditions are a cycle of 0.05 C, a voltage range of 2.2V to 3.7V, and a temperature of 55° C.

FIG. 11 is the cycle number and capacity retention rate curves of example 1, example 2, example 3, and example 4, and the operating conditions are 3 cycles at 0.05 C and 30 cycles at 0.1 C, and the voltage range is 2.2V to 3.7 V. The temperature is 55° C.

FIG. 12 is the discharge capacity and coulombic efficiency curves of examples 6 and 7, and the operating conditions are 3 cycles at 0.05 C and 50 cycles at 0.1 C, the voltage range is 2.2V to 3.7V, and the temperature is 55° C.

FIG. 13 and FIG. 14 is the discharge capacity and coulombic efficiency curves of examples 8, 9, and 10, and the operating conditions are 3 cycles at 0.05 C and 30 cycles at 0.1 C, the voltage range is 2.2V to 3.7V, and the temperature is 55° C.

FIG. 15 is a graph of discharge capacity and coulombic efficiency of example 11, and the operating conditions are 30 cycles at 0.1 C, a voltage range of 2.2V to 3.7V, and a temperature of 55° C.

The operating conditions of the AC impedance diagram in FIG. 16 are to set the AC impedance frequency range to 100 MHz to 7 MHz and the amplitude to 10 mV.

In addition, the electrical test results of examples are shown in Table 2.

TABLE 2

| | | | | capacity | capacity |
|---|---|---|---|---|---|
| | charging | discharging | | retention | retention |
| | capacity | capacity | coulombic | rate in | rate in |
| | in 1^{st} cycle | in 1^{st} cycle | efficiency | 10^{th} cycle | 30^{th} cycle |
| | (mAh/g) | (mAh/g) | (%) | (%) | (%) |
| Example 1 | 202.6 | 152.1 | 75.1 | 31 | 1.9 |
| Example 2 | 184.6 | 138.5 | 74.9 | 51.9 | 1.9 |
| Example 3 | 202 | 137.1 | 66.7 | 71.9 | 12.4 |
| Example 4 | 152.2 | 94.2 | 61.8 | 86.5 | 60.3 |
| Example 5 | 195.8 | 149.6 | 76.4 | 70.1 | 24.7 |
| Example 6 | 243.5 | 198.5 | 81.5 | 67.8 | 27.2 |
| Example 7 | 234.3 | 196.6 | 83.9 | 78.1 | 53.9 |
| Example 8 | 188.9 | 166.5 | 88.2 | 1.4 | 0.2 |
| Example 9 | 183.4 | 139.1 | 75.9 | 23.5 | 0.8 |
| Example | 169.2 | 138.7 | 86.9 | 57.6 | 8.1 |
| 10 | | | | | |
| Example | 183.3 | 163.7 | 89.3 | 96.8 | 84.1 |
| 11 | | | | | |

It may be seen from the results of the above-mentioned FIG. 2 to FIG. 16 and Table 2 that the positive electrode layer materials of the solid lithium battery in the examples of the disclosure (example 2 to example 11) include oxygen doped materials, graphene materials or lithium indium chloride materials, compared with the comparative example (example 1), the disclosure has better electrochemical stability and may also maintain similar electrical performance. For example, in some examples, at a current density of 0.1 C, the first-cycle reversible capacitance may reach about 180 mA/g, after 50 cycles of charge and discharge, it still retains about 80% capacity retention rate. In addition, when the solid electrolyte layer of the solid lithium battery in the embodiment of the disclosure uses oxygen doped materials (example 7, example 11) and/or the lithium indium alloy used in the negative electrode layer, compared with the comparative example (example 1), it also has better electrochemical stability while maintaining similar electrical performance.

Based on the above, the solid lithium battery of the disclosure at least adopts the design of the positive electrode layer which introduces the second solid electrolyte and/or conductive additive with lower reactivity therein, such that the solid lithium battery has better electrochemical stability while maintaining electrical performance.

Although the disclosure has been disclosed in the above embodiments, the embodiments are not intended to limit the disclosure. It will be apparent to persons skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A solid lithium battery, comprising:
a negative electrode layer;
a solid electrolyte layer, comprising a first solid electrolyte; and
a positive electrode layer, comprising an active material, a second solid electrolyte, a conductive additive, and an adhesive, wherein:
a material of the second solid electrolyte comprises oxygen-doped sulfide or lithium indium chloride; and/or
a material of the conductive additive comprises graphene.

2. The solid lithium battery according to claim 1, wherein the oxygen-doped sulfide comprises Li₆PS₅₋ₓClOₓ, Li₆PS₅₋ₓBrOₓ, Li₆PS₅₋ₓIOₓ or a combination thereof, x=0˜1.

3. The solid lithium battery according to claim 1, wherein a weight ratio of the second solid electrolyte to a total weight of the positive electrode layer is greater than 20 wt %.

4. The solid lithium battery according to claim 1, wherein a weight ratio of the conductive additive to a total weight of the positive electrode layer is less than 20 wt %.

5. The solid lithium battery according to claim 1, wherein a weight ratio of the active material to a total weight of the positive electrode layer ranges from 60 wt % to 80 wt %.

6. The solid lithium battery according to claim 1, wherein a weight ratio of the adhesive to a total weight of the positive electrode layer ranges from 1 wt % to 5 wt %.

7. The solid lithium battery according to claim 1, wherein a number of layers of the graphene ranges from 3 layers to 20 layers.

8. The solid lithium battery according to claim 1, wherein a material of the first solid electrolyte is same as a material of the second solid electrolyte.

9. The solid lithium battery according to claim 1, wherein the material of the conductive additive further comprises carbon black, gas phase carbon fiber, or carbon nanotube.

10. The solid lithium battery according to claim 1, wherein a material of the negative electrode layer comprises lithium, indium or a combination thereof.
